(19) United States
(12) Patent Application Publication
(10) Pub. No.: US 2021/0392116 A1
(43) Pub. Date: Dec. 16, 2021

(54) Privacy Protection Camera

(71) Applicant: NCS Pte. Ltd., Singapore (SG)

(72) Inventors: Hsueh Cheng Sagin HSU, Singapore (SG); Chi-Tong Lechee LAI, Singapore (SG); Yingyu XIA, Singapore (SG)

(21) Appl. No.: 17/250,940

(22) PCT Filed: Oct. 2, 2018
(86) PCT No.: PCT/SG2018/050500

§ 371 Date: Mar. 31, 2021

(51) Int. Cl. H04L 29/06; H04N 5/232; G06K 9/00; H04N 7/025; H04N 7/18

(52) U.S. Cl. CPC H04L 63/0421; H04N 5/23229; G06K 9/00288; H04L 63/08; H04N 7/183; H04L 63/0428; H04N 7/025

(57) ABSTRACT

A video camera may create an anonymized video stream by detecting people's faces, then anonymizing the faces by pixelating the faces. The camera may be a single housing where the outbound transmissions may be restricted to anonymized content. Some devices may include a secure portal or access mechanism by which authorized users may access raw video prior to the anonymization process, or may be able to receive information that may assist in identifying individual people in the video feed. The authorized users may provide credentials or have some other mechanism to gain access to the sensitive raw video feed. The devices may embed the anonymization routines into hardware or software such that a raw video feed may be unavailable when initially installed.

### CROSS REFERENCE TO RELATED APPLICATIONS

This application claims priority to and benefit of PCT Application Serial Number PCT/SG2018/050500, entitled “Privacy Protection Camera” filed 2 Oct. 2018 by NCS, Pte. Ltd., the entire contents of which are hereby incorporated by reference for all it discloses and teaches.

### BACKGROUND

Video and still cameras used in public places may capture people's faces. In many cases, such cameras may be connected to the Internet and may be used for judging the traffic congestion on a street or in a train station, for example. By capturing people's faces, a person's image may be made public. In some jurisdictions, such a transmission may violate the person's privacy.

Personal privacy in today's ubiquitous internet and social media is a large concern to many individuals. People often do not want their images made public, especially when their location or association may infer other information. For example, a video camera may capture images of persons entering or leaving a religious or political organization. Such images may be used to target such people for nefarious means or merely to violate the people's freedom to participate in those organizations.

In the past, people's images on a video or still image may not raise many concerns, but with today's technology, a facial recognition software product may be populated with publicly available databases of people's faces from social media. Such technology is becoming widely available and therefore any public image may be analyzed to identify people in those images.

### SUMMARY

A video camera may create an anonymized video stream by detecting people's faces, then anonymizing the faces by pixelating the faces. The camera may be a single housing where the outbound transmissions may be restricted to anonymized content. Some devices may include a secure portal or access mechanism by which authorized users may access raw video prior to the anonymization process, or may be able to receive information that may assist in identifying individual people in the video feed. The authorized users may provide credentials or have some other mechanism to gain access to the sensitive raw video feed. The devices may embed the anonymization routines into hardware or software such that a raw video feed may be unavailable when initially installed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a privacy enabled camera.

FIG. 2 is a diagram illustration of an embodiment showing a network environment with a privacy enabled camera.

FIG. 3 is a flowchart illustration of an embodiment showing a method for an initial power on sequence for a privacy enabled camera.

FIG. 4 is a flowchart illustration of an embodiment showing a method for processing images from a camera sensor.

FIG. 5 is a flowchart illustration of an embodiment showing a method for configuring a privacy enabled camera for non-anonymized access.

FIG. 6 is a flowchart illustration of an embodiment showing a method for accessing non-anonymized information from a privacy enabled camera.

### DETAILED DESCRIPTION

Privacy Protection Camera

Overall Device

A video camera may produce anonymized video feeds by detecting human faces and removing those faces from the video feed. The resulting anonymized video feed may show human faces as pixelized images, blank areas, or some other anonymized representation. The human face detection mechanism and anonymization mechanism may be embedded in the device such that during initial installation, raw or non-anonymized images may not be accessible.

The video camera may be a single device with an image sensor and lens systems, an output mechanism, and a processor that may detect faces and obscure or anonymize the faces prior to transmitting a video feed on the output mechanism. Such an embodiment may be a privacy-enabled camera that operates in such a mode by default, thereby only generating anonymized video streams when installed.

The video camera may be controllable remotely, and may, for example, have a computer-controlled zoom or focus features. Some cameras may also include pan and tilt control. A user may access the remote control features to change the camera angle and field of view.

The remote control may also include remotely configuring the camera device. In some cases, a remote connection may be established to configure the camera to transmit a non-anonymized video stream. Typically, such a configuration may include providing credentials or authenticating a connection prior to being permitted to access the non-anonymized video stream.

It should be noted that throughout this specification and claims, the term “video feed” is used as a general descriptor of the images produced by a camera. In many cases, the video feed may be a motion picture video feed, with images being transmitted continually. In other cases, however, the camera may produce individual images which may be anonymized. The example of a video feed shall be considered to apply to embodiments where individual images may be created.

Camera Interfaces

A privacy enabled camera may have a minimal external interface. Since the camera may be designed for providing anonymized video, the mechanical and software interfaces for the camera may not be overly complex.

The camera's mechanical or mounting interfaces may include one or more mechanisms for securing the camera to a wall, ceiling, vehicle, or other location. The mounting interfaces may include a pan and tilt mechanism by which the camera may be pivoted to change the view.

The camera may include one or more network interfaces. The network interfaces may be wired or wireless. In some cases, one connection may provide anonymized streams, while another connection may provide raw video streams or otherwise provide personally identifiable information regarding the people who may be in an image or video.

A camera's software interfaces may include an administrative interface through which various setup and configuration operations may be performed. Such operations may include configuring a device's network connections, adjusting any parameters concerning the video feed that may be produced, as well as setting up access to any personally identifiable information about people captured in a video feed.

Any access to personally identifiable information, such as people's faces, may be granted access after providing credentials. The credentials may restrict access to personally identifiable information only to those people who are authorized to access such data. In many devices, an anonymized video feed may be accessible without having to provide authenticated credentials, but such credentials may be required prior to accessing personally identifiable information. Some devices may require one set of credentials for the anonymized feed, while requiring a second set of credentials for a non-anonymized feed.

Anonymized and Non-Anonymized Video Feeds

A camera may produce anonymized video feeds, and in some instances, non-anonymized video feeds. Anonymized images may be produced by detecting human faces in an image, then obscuring the faces beyond detection. The resulting image or video feeds of such images, may be obscured such that recreating the original image may be impossible.

Several different types of non-anonymized video feeds may be produced. One non-anonymized video feed may be the raw video feed with no facial recognition or other processing. Another may be a feed that may include images of people recognized in the video feed. Such a feed may be used in parallel with the anonymized video feed for security and other uses. Still another feed may be a metadata feed that may include metadata describing faces recognized in the raw video feed.

The facial detection technology may analyze images within a video stream to detect human faces. Such analyses may be performed in real time or near-real time on a video stream. In many cases, a facial detection algorithm may return a set of coordinates representing the location of the human face within the image. An obfuscation technique may be applied within the coordinates to obscure the face, thereby generating an anonymized face.

A face may be obscured by several mechanisms. For example, a face may be obscured by pixelating or mosaicking the area of the face. Another method may be to replace the face with a solid color, such as grey or flesh tone. The resulting obscured image may not be able to be analyzed to reverse the obscured image to determine the original image.

Some cameras may allow authorized users to access a non-anonymized feed. The non-anonymized feed may be the original video feed prior to anonymization, or may be a separate set of data that may be used to identify people in the video. Some systems may include audit related information. Such information may be in an access log, where actions of an administrator or other authorized user may be tracked and stored. In many such systems, the data accessed by the authorized user may be tracked such that any data breach may be traced back to the person who may have originally accessed the data.

Some systems may perform some analysis of a detected face and may generate information from which a person may be identified. For example, some systems may identify a human face and may capture a representative image of the face. The representative image may be tagged to a frame or time stamp of a video stream, and may include a set of coordinates to determine where in the image that particular face was found.

In another example, a facial detection algorithm may perform some steps of facial recognition by generating a set of measurements that may be used by a facial detection comparison algorithm. In such an example, a camera device may analyze a face from an image and generate a set of features from the face, and those features may be used by a facial recognition system to compare the captured face with a database of known faces. In such an example, the camera may perform a step of characterizing a captured image of a face, then a second step of comparing the characterized parameters against a database may be performed by a second system.

Use Cases

A privacy enabled camera may have several use cases. For example, such cameras may be used for monitoring foot traffic in public areas, maintenance and janitorial inspection, monitoring hospital or healthcare facilities.

Monitoring public areas may be performed using privacy enabled cameras. For many uses, anonymized video feeds may be adequate to perform a function. For example, a camera may be used to monitor the number of people in a specific area and where those people might be going. The density, speed, and direction of foot traffic may be determined without need to identify any of the people, and therefore a privacy enabled camera may fulfil the goal of such analysis. By removing the personally identifiable information from the video feed, analyses such as traffic density may be performed without having to expose people's identities. Such analyses may then be performed on less secure systems and such video feeds may be more widely distributed to others who may perform various analyses on the video feeds.

Cameras in public spaces may, however, also capture information that may be useful to police. For example, if a crime were committed on camera or where a suspect may be fleeing a scene of a crime, the police may have a need to access the personally identifiable information in a video feed to aid in their investigation.

In some jurisdictions, the police or other similar agencies may have legal authority to access live video feeds that may include personally identifiable information. In some situations, a video feed may be stored along with the personally identifiable information, and the personally identifiable information may be accessed after receiving a judicial warrant.

Another use case may be for surveillance systems that may be used in part for maintenance and janitorial reasons. In one such use case, a video camera may be used to inspect the cleanliness of a public area, such as a train station. In such a use case, any people in the video may be unwanted, as the people may block the areas being inspected. Such a use case may block the human faces such that the maintenance inspection may be performed without exposing the maintenance inspector to any personally identifiable information.

A third use case may be in a hospital or healthcare environment. In such an environment, patient's rights to medical privacy may place restrictions on who can view raw images that may contain a person's face. By generating an anonymized video stream, the video stream may serve many purposes without sacrificing patient's privacy.

For example, a hospital may install privacy enabled cameras in hallways for general security monitoring. If a patient were to fall, for example, a security guard may be able to alert the medical staff that a patient needs assistance. However, the security guard may be unable to tell who the patient may be, thereby ensuring that the patient's privacy may not be violated.

However, a hospital camera system may have certain circumstances where identifying people in a security camera may be valuable. For example, a diagnosis of a highly infectious disease in a hospital may trigger a need to identify those people, including staff and patients, who may have had contact with the disease. In such a case, the video may be analyzed to identify each person in the vicinity of the disease and alert those people or contain them to prevent further spread of the infectious disease.

In the examples of the use cases, a privacy enabled camera may generate anonymized video feeds that may be used for a wide variety of uses without encumbering those uses. Because the video feeds may be anonymized, any privacy restrictions that may have limited dissemination and use of the video feeds may be lifted. The anonymized video feeds may be more widely available to different agencies, companies, or individuals for their consumption than the non-anonymized video feeds, and thereby more uses of the video may be found while maintaining a higher level of privacy for the general public.

Some use cases may include various audit mechanisms, which may log any authenticated users and their accesses of non-anonymized video. Some systems may use various authentication mechanisms, such as public key infrastructure (PKI) authentication, where the authenticated user may be identified and their operations tracked. Such systems may allow auditors to trace accesses and content of non-anonymized content.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

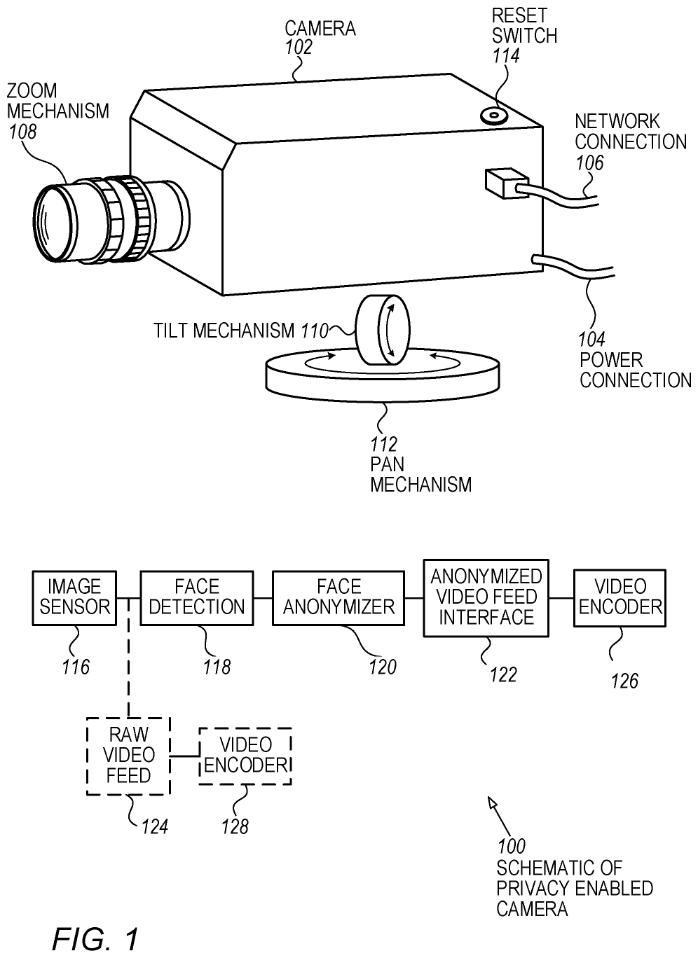

FIG. 1 is a diagram illustration of an embodiment 100 showing a privacy enabled camera. Embodiment 100 may be a camera that may be mounted in public areas where the faces of people in a video stream may be anonymized to protect the public's privacy.

A camera 102 may represent a conventional video camera but with an internal processing capability to detect human faces then obscure the faces. The camera 102 may operate in an anonymizing mode as a default or standard configuration. In some cases, the camera 102 may be able to generate and transmit non-anonymized video feeds or other information that may allow for a person to be identified from the video.

The camera 102 may be configured to send anonymized video feeds by default. In such a configuration, the camera may be installed, turned on, and may insure people's privacy without any further configuration. In some cases, a camera may have an administrative user interface by which a user may be able to configure non-anonymized feeds which may be accessed after proper authentication.

The camera 102 may have a power connection 104 and network connection 106. In many cases, the camera 102 may have a very limited set of interfaces such that unauthorized access to a non-anonymized video stream may be difficult or impossible to access without credentials. Some cameras may be equipped with a reset switch 114 or other limited user interface. Such cameras may be accessible through the network connection 106 where a user may receive anonymized video feeds, and when properly authenticated, may access an administrative user interface where the camera 102 may be configured.

The network connection 106 may be illustrated as a hard-wired network connection, although some embodiments may use a wireless connection. In some cases, two or more network connections may be present. Some such embodiments may have one network connection used for non-anonymized video while another network connection may be used for anonymized video.

A zoom mechanism 108, as well as a tilt mechanism 110 and pan mechanism 112 may be remotely controllable adjustments. A zoom mechanism 108 may allow a user to remotely zoom in and out, and the tilt and pan mechanisms may allow a user to direct the camera's image in a desired location. Some versions of the camera 102 may not include some or all of the remotely controllable adjustments.

The operation of the camera 102 may capture a video feed from an image sensor 116, perform facial detection 118, anonymize the faces using a face anonymizer 120, and generate an anonymized video feed 122 which may be encoded by a video encoder 126. In some cases, a raw video feed 124 may be generated, which may be accessible to authorized users after encoding by a video encoder 128.

Some such designs may include a single printed circuit board where a camera sensor may be connected to a processor that may perform facial detection and obscuration prior to a video feed leaving the printed circuit board. Such a design may ensure that no mechanical interface may be available to access a raw video feed. Such designs may still permit an authorized user to configure access to a raw video feed or other personally identifiable information about people captured in the video feed.

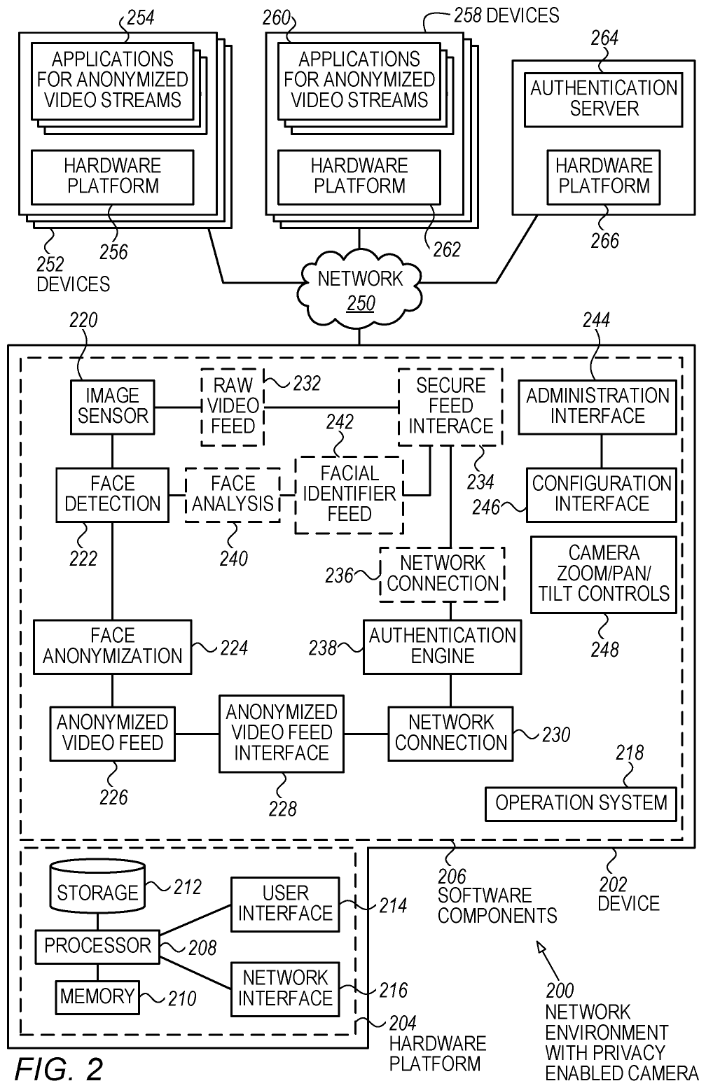

FIG. 2 is a diagram of an embodiment 200 showing components in a camera system, as well as various other components that may be accessed over a network connection. Embodiment 200 may be an example architecture that may perform the functions of a privacy enabled camera, although other embodiments may have different architectures and different configurations.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

An image sensor 220 may capture video images. The images may be processed by a facial detection component 222, and any faces may be anonymized using a facial anonymization component 224, resulting in an anonymized video feed 226. An anonymized video feed interface 228 may be processed by an encoder 227, then made available on an anonymized video feed interface 228, which may be accessed through a network connection 230.

The anonymized video feed interface 228 may be a user interface accessed through the network interface 228 through which the anonymized video feed 226 may be accessed. The interface 228 may be a software interface where a user may be able to select different parameters about the anonymized video feed 226, such as the frame rate frequency, resolution of the images, and other aspects. In some cases, the user may access the interface 228 to control the camera's zoom, pan, and tilt controls, when available.

The interface 228 may be accessible with or without authentication. Credentials may be authenticated through an authentication engine 238. Some embodiments may permit access to the anonymized video feed without providing authentication credentials, while other embodiments may require authentication prior to access. Some may permit access to an anonymized video feed without credentials, but may require credentials to access various configuration and control capabilities, such as changing camera direction or zoom controls.

Some embodiments may generate a raw video feed 232, which may be made available, after encoding with the encoder 241, through a secure feed interface 234 over a network connection 236. The raw video feed 232 may be a video feed where human faces have not been anonymized. In some embodiments, a second, separate network connection 236 may permit access to a raw video feed 232, while in other embodiments, both the anonymized video feed and non-anonymized video feed may be accessed through the same network connection.

Some embodiments may perform facial analysis 240 to generate a facial identifier feed 242, which may be encoded by an encoder 241 and made available on a secure feed interface 234. A facial identifier feed 242 may include information that may assist in identifying people in a video feed. Embodiments that may include a facial identifier feed 242 may not generate a raw video feed 232.

A facial identifier feed 242 may include any information that may assist in the identification of a person in a video feed. For example, some facial identifier feeds may include a representative image of the person who may have been anonymized in the anonymized video feed. Such an image may include coordinates and a frame identifier so that the representative image or other identifying information may be tied back to a location in the video feed.

Another facial identifier feed may be a set of parameters that may be performed as part of a facial recognition algorithm. For example, a facial recognition algorithm may generate a set of description parameters that may describe a person's face mathematically. These parameters may be compared against a database of known persons to determine a match. In such a system, the mathematical parameters may be generated by the camera, then made available in a facial identifier feed 242.

Many feeds may be encrypted prior to transmitting. The anonymized video feed 226 may be encrypted prior to transmitting in some cases, while in other cases, the anonymized video feed 226 may be made available without encryption.

The facial identifier feed 242 or the raw video feed 232 may be encrypted prior to transmitting. In some cases, the facial identifier feed 242 or the raw video feed 232 may be encrypted and embedded into the anonymized video feed 226. The embedding of encrypted information into the anonymized video feed 226 may allow the anonymized video feed to be widely disseminated, yet while retaining the information to still identify people within the video.

A camera device 202 may have an administrative interface 244, where a user may be able to access various controls, such as zoom, pan, and tilt controls 248, amongst other controls. From the administrative interface 244, a configuration interface 246 may be accessed. The configuration interface 246 may be a mechanism to establish a raw video feed or facial identifier feed, as well as to establish credentials for accessing such feeds.

The device 202 may be connected to a network 250 where other devices may also connect. For example, one set of devices 252 may have applications 254 that may consume anonymized video streams. These devices 252 may operate on various hardware platforms 256. Similarly, another set of devices 258 may have applications 260 that may consume the non-anonymized or secure video streams, and may operate on various hardware platforms 262.

The applications 254 that may consume the anonymized video feeds may include any type of application or use case where the identity of people in the video are immaterial or of secondary nature. For example, a video of a train station may be used to judge the traffic patterns, wait times, congestion, or factors such as the cleanliness of the station. Such use cases may not require the knowledge of a person's identity.

The applications 260 that may consume the secure video feeds may be those application where a person's identity may be important to the specific task. For example, applications where criminal suspects may be identified may require an ability to positively identify specific people in a video.

An authentication server 264 may operate on a hardware platform 266, and may authenticate credentials for access to the anonymized video feeds or the various secure video feeds.

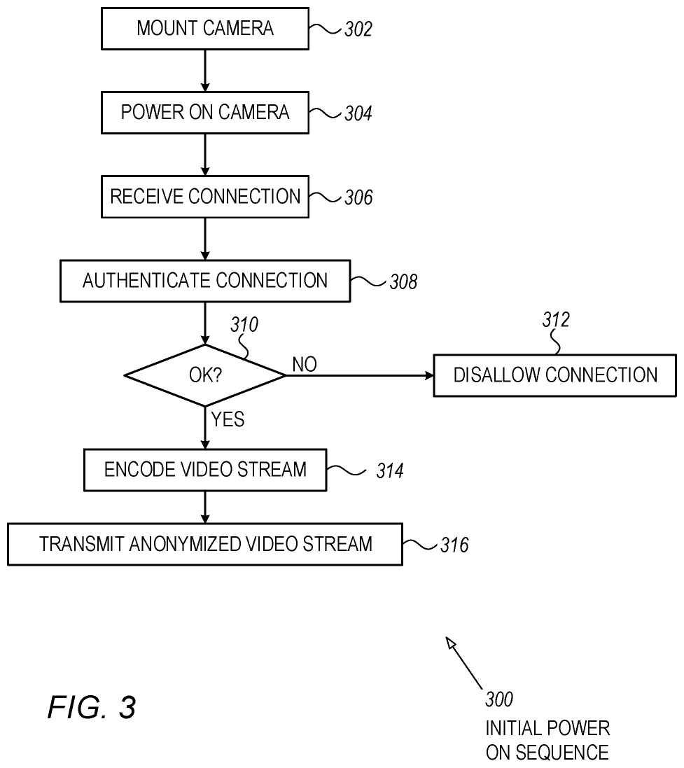

FIG. 3 is a flowchart illustration of an embodiment 300 showing a power on sequence for a privacy enabled camera. Embodiment 300 is a simplified method showing the steps performed by a camera during startup.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of the steps that may be performed during the installation of a privacy enabled camera. The power on sequence may be the first operations that occur when a customer installs the camera and turns it on. In the sequence, the camera may be configured to produce anonymized video from the beginning.

A camera may be mounted in block 302 and turned on in block 304. A connection may be established in block 306 with another device, which may be authenticated in block 308. If the authentication is improper in block 310, the connection may be disallowed in block 312. If the authentication is proper in block 310, the camera may encode the video stream in block 314 and begin transmitting an anonymized video stream in block 316.

Some embodiments may permit access to an anonymized video stream without providing credentials and authentication. Such cameras may produce anonymized video streams that may be publicly accessible without authentication, and such a configuration may be acceptable in various jurisdictions where surreptitiously capturing people's faces on video may be illegal or otherwise improper or undesirable.

The sequence of embodiment 300 may illustrate that a privacy enabled camera may produce anonymized video initially. Such a configuration may be different from conventional cameras where raw video may be initially produced, and if an anonymized video stream may be desired, an anonymization process may be added to the video stream.

The privacy enabled camera may be configured to produce anonymized video by default. Such a camera may require extra configuration to access non-anonymized video, or such non-anonymized video may not be available at all from the camera. Such a camera may ensure the public's privacy by allowing only authorized personnel to access the non-anonymized video, and by only generating anonymized video from the initial setup and power on actions. This may mean that the personnel who install and configure the cameras may not have any access to the non-anonymized video, thereby removing a security risk.

Because the cameras may produce anonymized video by default, the cameras may ensure that people's privacy may be inherently protected. The only video produced with such a camera, at least without proper authenticated access, may be anonymized video. Such cameras may address the public's concern about their personal privacy, as well as any legal or regulatory restrictions on capturing people's images without consent.

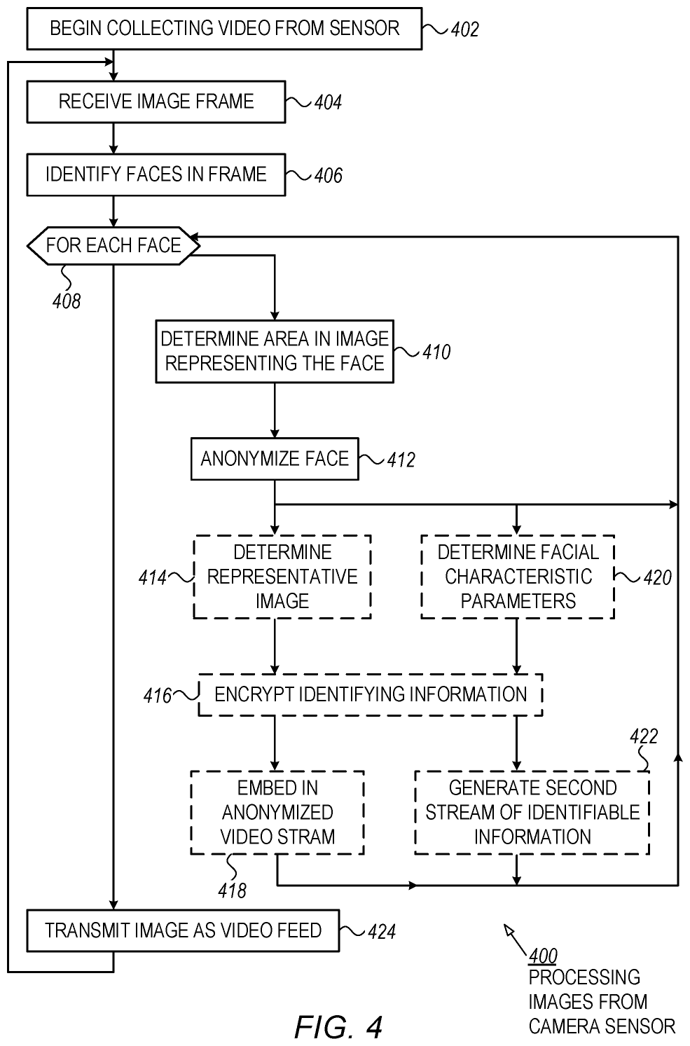

FIG. 4 is a flowchart illustration of an embodiment 400 showing a sequence for processing images captured from a camera sensor. Embodiment 400 is a simplified method showing the steps to anonymize a video stream.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 may illustrate a method where people's faces are detected then anonymized. Additionally, some embodiments may create information that may permit authorized users to identify the people whose faces were obscured. The identifying information may include creating a representative image of the obscured person or may include mathematical parameters that may define characteristics used by facial matching algorithms.

The example of embodiment 400 may illustrate two different methods by which information may be generated that may assist in the identification of people captured in the video. Such information may be embedded into the anonymized video stream or may be transmitted separately from the anonymized video stream.

A sensor may begin collecting video in block 402. A first image frame may be received in block 404 and any faces in the frame may be identified in block 406.

For each of the identified faces in block 408, the area in the frame representing the face may be identified in block 410. The area in the frame representing the face may be anonymized in block 412.

Various methods may be used to anonymize the face in a video image. For example, some embodiments may pixelate or mosaic the area of the face. Other embodiments may replace the face with a solid color, and still others may replace the face with an avatar or some other image. In many such methods, the face may be obscured to the point that the face may not be reconstructed from the resulting anonymized image.

In some embodiments that produce only anonymized video streams, the process may return to block 408.

In other embodiments where identifiable information may be available to authenticated users with the proper permissions, several different types of identifiable information may be available. Some embodiments may produce a raw video feed, which is not illustrated in this embodiment. Other embodiments may produce a representative image in block 414 or determine facial characteristic parameters in block 420. This identifying information may be encrypted in block 416, and may be either embedded in the video stream in block 418 or a separate stream of identifiable information may be generated in block 422.

Once all of the faces are processed in block 408, the frame may be transmitted as part of a video feed in block 424 and the process may return to block 404 to process another frame.

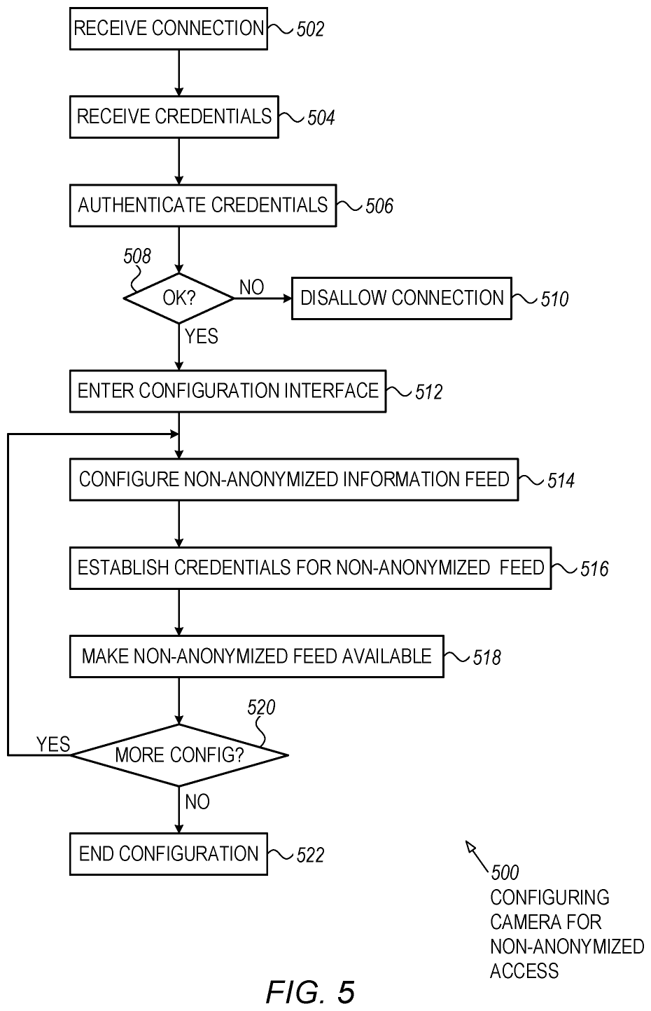

FIG. 5 is a flowchart illustration of an embodiment 500 showing a method for configuring a camera for non-anonymized access. Embodiment 500 is a simplified method showing the steps to establish a non-anonymized information feed and define credentials for access to such a feed.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 may illustrate a process for configuring access to information from which person's identities may be determined from a video feed. In some cases, a non-anonymized information feed may be a raw video feed where people's faces are not obscured.

A connection may be received in block 502 as well as credentials in block 504. The credentials may be authenticated in block 506, but if the authentication fails in block 508, the connection may be disallowed in block 510.

If the credentials are properly authenticated in block 508, a configuration interface may be entered in block 512. In many embodiments, the configuration interface may be a software interface that may be transmitted to and displayed on a user's device. One such manner for defining such a user interface may be through HTML, for example.

A user may configure the non-anonymized information feed in block 514. Depending on the features available in the device, the user may select the type of non-anonymized information feed, the frequency of transmission, any network connection configurations or protocols, or other variables with the information feed.

A user may establish credentials for accessing the non-anonymized feed in block 516. In some cases, the user may determine the type and level of encryption, establish public/private keys for encryption, or perform other types of credential and encryption configuration.

The information feed may be made available in block 518. If additional configuration settings may be desired in block 520, the process may return to block 514. If no additional configuration settings may be desired in block 520, the configuration may end in block 522.

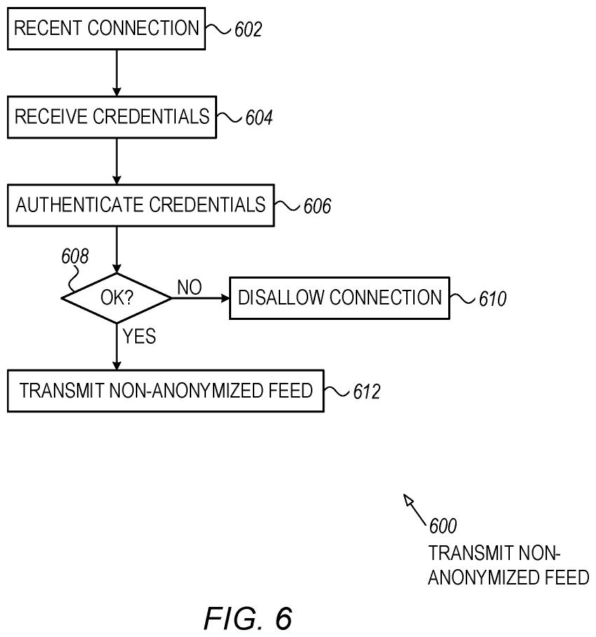

FIG. 6 is a flowchart illustration of an embodiment 600 showing a method for accessing non-anonymized information from a privacy enabled camera.

Embodiment 600 is a simplified method for gaining access to non-anonymized information.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 may illustrate how a credentialed user may access non-anonymized information from a privacy enabled camera. The camera may be configured such that only authorized and authenticated connections may receive information that may identify or assist in identifying persons captured in a video stream.

A connection may be received in block 602 along with credentials in block 604. The credentials may be authenticated in block 606, and if the authentication failed in block 608, the connection may be disallowed in block 610. If the credentials may be properly authenticated in block 608, the non-anonymized feed may be transmitted in block 612.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1-20. (canceled)

21. A device comprising:
a housing;
an image sensor attached to said housing;
a first network connection attached to said housing;
at least one processor attached to said housing and configured to perform a method comprising:
receiving a video stream from said image sensor;
identifying a human face within said video image;
obfuscating said human face to create an anonymized video stream; and
transmitting said anonymized video stream on said first network connection;
said anonymized video stream being a default video stream generated by said device.

22. The device of claim 21, said default video stream being the only video stream generated by said device.

23. The device of claim 21, said default video stream being the only video stream provided by said device when said device is initially operated.

24. The device of claim 22, said default video stream being the only video stream accessible from said first network connection without authenticated credentials.

25. The device of claim 24, said method further comprising:
generating a raw video stream comprising said video stream;
receiving said authenticated credentials; and
transmitting said raw video stream after receiving said authenticated credentials.

26. The device of claim 25, said raw video stream being encrypted prior to said transmitting.

27. The device of claim 25 further comprising a second network connection, said raw video stream being transmitted on said second network connection.

28. The device of claim 27, said first network connection and said second network connection being virtual connections having a common hardware network interface.

29. The device of claim 27, said first network connection being made on a first hardware network interface and said second network connection being made on a second hardware network interface.

30. The device of claim 21, said method further comprising:
identifying a first face within said video stream;
creating an identification characteristics for said first face; and
transmitting said identification characteristics in parallel with said anonymized video stream.

31. The device of claim 30, said identification characteristics being transmitted in encrypted form.

32. The device of claim 30, said identification characteristics being embedded in said anonymized video stream.

33. The device of claim 30, said identification characteristics being transmitted in a second transmission stream.

34. The device of claim 30, said identification characteristics comprising a representative image of said first face.

35. The device of claim 30, said identification characteristics comprising a set of facial characteristics.

36. The device of claim 30, said identification characteristics comprising a set of coordinates within said video stream for said first face.

37. The device of claim 30, said identification characteristics being accessible only after providing authentication credentials.

38. The device of claim 30, said identification characteristics being transmitted on a second network connection.
